(19) United States
(12) Patent Application Publication
(10) Pub. No.: US 2016/0299340 A1
(43) Pub. Date: Oct. 13, 2016

(54) REAL-TIME OPTICAL PROJECTIVE DISPLAYING SYSTEM IN VEHICLE

(71) Applicants: RAYMOND WANG, TAICHUNG CITY (TW); RAYSHINE PHOTONICS CORP., TAICHUNG CITY (TW)

(72) Inventor: RAYMOND WANG, TAICHUNG CITY (TW)

(21) Appl. No.: 14/871,028

(22) Filed: Sep. 30, 2015

(30) Foreign Application Priority Data
Apr. 13, 2015 (TW) 104111758

(51) Int. Cl. G02B 27/01; G06T 3/60; B60R 1/00

(52) U.S. Cl. CPC G02B 27/0101; B60R 1/00; G06T 3/60; G02B 2027/0118; G02B 2027/0141; G02B 2027/0196; G02B 2027/0194; G02B 2027/014; G02B 2027/0145; B60R 2300/205

(57) ABSTRACT

A real-time optical projective displaying system for vehicles (ex: car) is disclosed. The system comprises: a trans-flective film adhered on a windshield of the vehicle, and an electronic mobile device with function of displaying electronic image such as navigation information. The electronic mobile device is placed beneath the trans-flective film and the screen of the electronic mobile device is aligned with the trans-flective film such that the electronic image can be projected in real time to the trans-flective film and then reflected into human eye with the electronic image is orientated in the direction same as the driving direction. Therefore, a driver can read the electronic image without heading down and looking at the electronic mobile device.

### FIELD OF THE INVENTION

The present invention relates to a real-time optical projective displaying system, particularly relates to a real-time optical projective displaying system in vehicle.

### BACKGROUND OF THE INVENTION

Since real-time navigation devices are exploited, more and more vehicles are equipped with them for navigation during driving. At beginning stages of developing relative devices, most of people directly use devices that are special designed for navigation purpose. But with the development of navigation application program on general mobile devices, more and more people use the navigation application programs installed in general mobile devices instead of the special navigation devices, especially for those who don't drive very often or go to unfamiliar places very often.

However, most drivers can be distracted by looking at the screens of their mobile phones during driving, and further possibly make more traffic accidents. In fact, many countries in the world prohibit driver from operating his/her mobile phone during driving, so that using mobile phone as a navigation tool is not convenient for the driver without any rider together. In this regard, a simple navigation system for resolving aforementioned problems is an issue on simple navigation for vehicles.

### SUMMARY OF THE INVENTION

A real-time optical projective displaying system in a vehicle is provided herein, which enables a driver directly read navigation information shown on his/her mobile phone by right viewing a windshield of the vehicle, instead of looking at a screen of the mobile phone. With the operation of application program in a mobile device or the allocation of a twice reflection unit, the image that is projected onto the windshield of the vehicle may perform a somatosensory direction consistent with the ones of the vehicle in moving.

A real-time optical projective displaying system in a vehicle is provided herein, which includes: a see-through plate saw through by a human eye; an optical processing film adhered on the see-through plate; and an optical display deposited beneath the see-through plate, position of the optical display being corresponding to position of the optical processing film adhered on the see-through plate and allowing the optical processing film to receive an electrical image shown on the optical display, wherein the electrical image is real-time projected onto the optical processing film through the optical display and reflected by the optical processing film into the human eye.

A real-time optical projective displaying system in a vehicle is provided herein, which includes: a see-through plate saw through by a human eye; a first optical processing film adhered on the see-through plate; a reflection plate saw through by the human eye and faced to the see-through plate; a second optical processing film adhered on the reflection plate and faced to the first optical processing film; and an optical display deposited beneath the see-through plate and between the see-through plate and the reflection plate, a screen of the optical display being aligned with both position of the first processing film adhered on the see-through plate and position of the second optical processing film adhered on the reflection plate, and allowing the second optical processing film to receive an electrical image shown on the optical display, wherein the reflection plate is near the optical display and has an angle between the screen of the optical display and the reflection plate, and wherein electrical image is real-time projected onto the second optical processing film through the optical display, reflected by the second optical processing film onto the first optical processing film, and reflected by the first optical processing film into the human eye.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic diagram illustrating a first exemplary real-time optical projective displaying system in a vehicle according to the present invention.

FIG. 2 is a schematic diagram illustrating a second exemplary real-time optical projective displaying system in a vehicle according to the present invention.

FIG. 3 is a schematic diagram illustrating a third exemplary real-time optical projective displaying system in a vehicle according to the present invention.

### DETAILED DESCRIPTION OF THE PREFERRED EMBODIMENT

A real-time optical projective displaying system in a vehicle will be illustrated herein. Other advantages and features of the invention will become more apparent with reference to the following detailed description of presently preferred embodiments thereof in connection with the accompany drawings, and the drawings are not necessarily to scale, and the size and relative sizes of some regions may have been exaggerated for clarity.

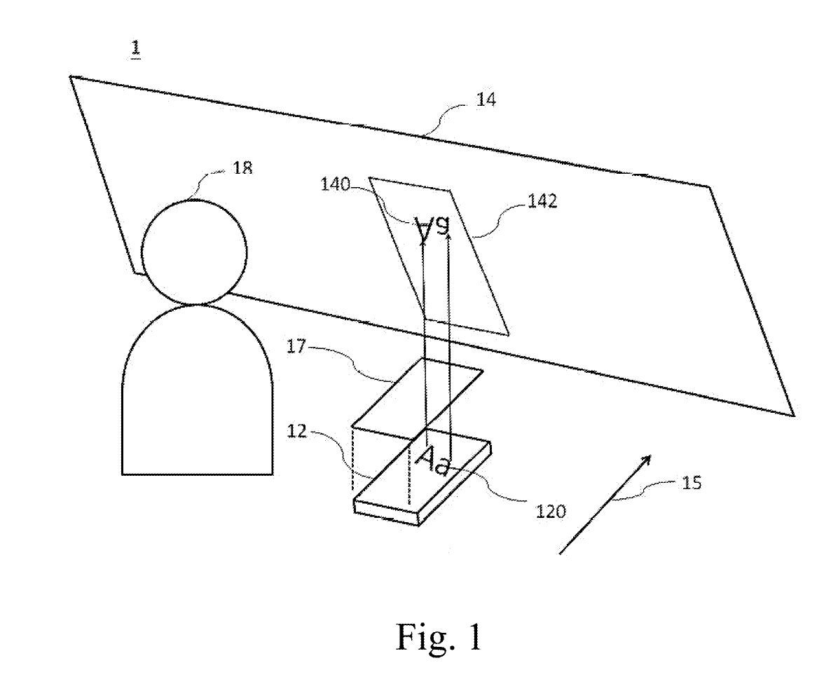

FIG. 1 is a schematic diagram illustrating a first exemplary real-time optical projective displaying system in a vehicle according to the present invention. Shown in FIG. 1, the first exemplary real-time optical projective displaying system 1 in the vehicle includes an optical display 12 and a see-through plate 14. The optical display 12 may be a display of electronic mobile device that can both store and display an electrical picture or an electrical image 120. The see-through plate 14 is a member that people may see through and a trans-flective film 142 is attached to. The optical display 12 may be flat deposited beneath the see-through plate 14 and the screen of the optical display 12 is aligned with the trans-flective film 142. The top of the electrical image 120 is directed to the see-through plate 14. As a result, the position that the trans-flective film 142 is adhered on the see-through plate 14 can be corresponding to the position of the optical display 12. Though an angle between the trans-flective film 142 and the optical display 12 is about 0˜180 degrees, or more then 0 degree and less than 180 degrees, the trans-flective film 142 can real-time receive the electrical image 120 shown on the optical display 12 so that the electrical image 120 can be projected onto the trans-flective film 142 to form a projection image 140. In this embodiment, the real-time optical projective displaying system 1 assists any electronic mobile device with the electrical image, such as navigation information, in projecting the electrical images onto the windshield of the vehicle, so as to a driver may directly read the electrical image of the electronic mobile device without bowing his/her head to look at the electronic mobile device. That is, the optical display 12 is the display of the electronic mobile device, the see-through plate 14 is the windshield of the vehicle, an observer 18 is the driver, and the vehicle goes forwards direction 15.

In this embodiment, the electrical image 120 is projected onto the trans-flective film 142 and reflected into the eyes of the observer 18. The image distinctness of the electrical image 120 is related to the polarity of the optical display 12 and the optical phase matching of the trans-flective film 142. Provided that the optical display 12 is equipped with a polarizer, the image distinctness may be managed by adjusting an alignment angle of the optical display 12 with respect to the trans-flective film 142, such as putting the optical display 12 flat and turning it right or left to make the direction of the optical display 12 (FIG. 1 for example, the long side of the optical display 12) have an angle of 15 to 45 degrees with respect to the trans-flective film 142 rather than be aligned with the trans-flective film 142. On condition that the optical display 12 is without the polarizer, the image distinctness may be managed by adding a polarizer or a phase difference plate onto the optical display 12 to optimize the polarity of the optical display 12 and the optical phase matching of the trans-flective film 142.

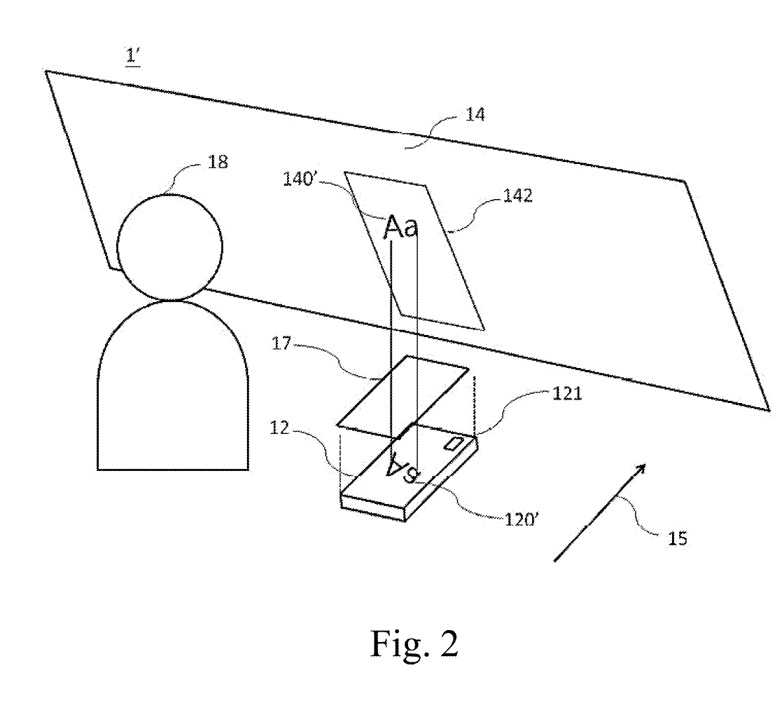

However, in the first example, if the electrical image 120 is an erect image in respect of the observer 18, such as erect alphabets “Aa” in FIG. 1, when the electrical image 120 is projected onto the trans-flective film 142 to form a projection image 140, it will be a reverse image of turning upside down shown in FIG. 1 in respect of the observer 18 and make image identification difficult. To prevent such a situation, FIG. 2 is a schematic diagram illustrating a second exemplary real-time optical projective displaying system in a vehicle according to the present invention. Shown in FIG. 2, compared to the real-time optical projective displaying system 1, a real-time optical projective displaying system 1′ further includes the optical display 12 having a real-time image reversion unit 121. With the real-time image reversion unit 121, the electrical image 120 shown on the optical display 12 may be inverted upside down when it is projected, or backside forward with respect to the direction 15, such as inverted alphabets “Aa” in FIG. 2, to form an inverted electrical image 120′. Next, the inverted electrical image 120′ is projected onto the trans-flective film 142 to form a projection image 140′, such as erect alphabets “Aa” in FIG. 2. The projection image 140′ is then reflected by the trans-flective film 142 and incident into the eyes of the observer 18. As a result, for the observer 18, the image direction of the projection image 140′ is same as the one shown on the optical display 12 in respect of a somatosensory direction. That is, for the observer 18, the direction of the projection image 140′ in the somatosensory direction is identical to the direction of the electrical image 120 and consistent with the direction 15. In the embodiment, a real-time image reversion unit 121 is an application software or program installed in an electronic mobile device such as a mobile phone. By the execution of the application program, the electrical image 120 shown on the optical display 12 may be real-time inverted and then projected onto the trans-flective film 142 for the real-time displaying erect images.

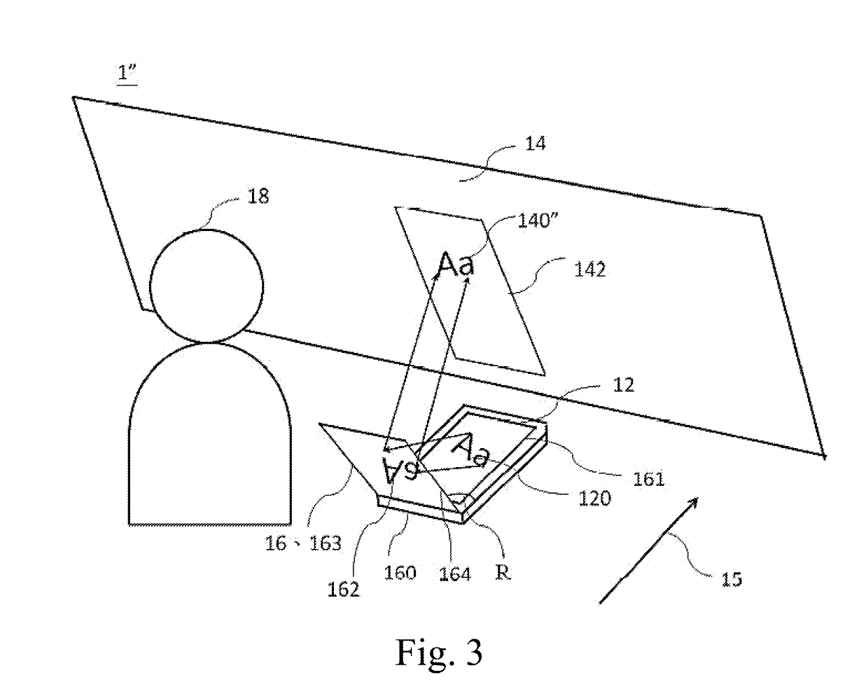

Next, FIG. 3 is a schematic diagram illustrating a third exemplary real-time optical projective displaying system in a vehicle according to the present invention. Shown in FIG. 3, compared to the real-time optical projective displaying system 1, a real-time optical projective displaying system 1″ further includes a display housing device 160. The display housing device 160 encloses hollow space 161 and includes a top lid 163 rotatable with respect to the hollow space 161. A reflection plate 16 is on the top lid 163 and another optical processing film 164 is adhered onto the reflection plate 16. The hollow space 161 of the display housing device 160 is configured to deposit or contain the optical display 12. The optical display 12 is so deposited that an angle R is formed between the screen of the optical display 12 and the reflection plate 16 of the top lid 163 after the top lid 163 is rotated and fixed. The angle R is between 90 to 180 degrees, and the optical display 12 is deposited between the rotated and fixed reflection plate 16 and the see-through plate 14. The reflection plate 16 is at one side of the optical display 12 and the optical processing film 164 is aligned with the screen of the optical display 12. The trans-flective film 142 of the see-through plate 14 is aligned with the screen of the optical display 12, too. The optical processing film 164 of the reflection plate 16 faces the trans-flective film 142 of the see-through plate 14. As a result, the electrical image 120 shown on the optical display 12 is projected onto the optical processing film 164 of the reflection plate 16 first to form a single time projection image 162, and then become a double-projection image 140″ on the trans-flective film 142. For the observer 18, the direction of the double-projection image 140″ is same as both the original electrical image 120 and the direction 15 in the somatosensory direction. Besides, the reflection plate 16 is see-through so that it would not have influence on vision from one side of the see-through plate 14 to another side thereof for the observer 18. In an example of this embodiment, the display housing device 160 may be a box for positioning or holding the optical display 12, the reflection plate 16 may be a lid of the box and be open and close rotatable to adjust the angle R between the reflection plate 16 and the optical display 12. In another example of this embodiment, the display housing device 160 may be a jointing device rather than a box to connect the optical display 12 and the reflection plate 16.

Accordingly, for the real-time optical projective displaying system 1, real-time optical projective displaying system 1′, and real-time optical projective displaying system 1″ in a vehicle, the optical display 12 may be the display of the electronic mobile device that both stores electrical pictures or electrical images and displays the electrical pictures or images, such as the display of a mobile phone with navigation function. The see-through plate 14 may be the windshield of the vehicle, the observer 18 is a driver, and the vehicle moves forwards the direction 15. Moreover, for the real-time optical projective displaying system 1, real-time optical projective displaying system 1′, and real-time optical projective displaying system 1″ in the vehicle, the electrical images of the electronic mobile device are projected onto the windshield, such as the projection image 140 or the projection image 140′ of the see-through plate 14, or the double-projection image 140″, so as to the observer 18 may directly read the electrical images 120 of the optical display 12 without bowing his/her head to look at the electrical image 120 shown on the optical display 12 of the electronic mobile device.

Besides, the trans-flective film 142 is see-through that people may see through, and the optical processing film 164 may be a trans-flective film. When they are applied to the real-time optical projective displaying system 1, real-time optical projective displaying system 1′ or real-time optical projective displaying system 1″, the trans-flective film 142 and the optical processing film 164 will not have influence on vision from one side of the see-through plate 14 to another side thereof for the observer 18. In the real-time optical projective displaying system 1″ of the third embodiment, the reflection plate 16 is also see-through, so that it will not prevent the observer 18 from seeing from one side of the see-through plate 14 to another side thereof. In another embodiment, the optical processing film 164 may be total reflection film.

Besides, in another embodiment, for the real-time optical projective displaying system 1 in the vehicle shown in FIG. 1, an image amplifying film 17 may be further set on the optical display 12, for example, a lens assembly consisted of diffraction optics. The image amplifying film 17 is deposited onto the optical display 12 and when the electrical image 120 of the optical display 12 passes through the image amplifying film 17, the electrical image 120 may be magnified and the projection image 140 is further magnified, too. Similarly, the image amplifying film 17 may be also configured to magnify the projection image 140′ and the double-projection image 140″ in the real-time optical projective displaying system 1, real-time optical projective displaying system 1′ and real-time optical projective displaying system 1″. It is understood that the image amplifying film 17 may be an element with the functions of polarity and image amplification.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A real-time optical projective displaying system in a vehicle, comprising:
a see-through plate saw through by a human eye ;
an optical processing film adhered on the see-through plate; and
an optical display deposited beneath the see-through plate, position of the optical display being corresponding to position of the optical processing film adhered on the see-through plate and allowing the optical processing film to receive an electrical image shown on the optical display, wherein the electrical image is real-time projected onto the optical processing film through the optical display and reflected by the optical processing film into the human eye.

2. The real-time optical projective displaying system in a vehicle of claim 1, wherein the optical processing film is a trans-flective film.

3. The real-time optical projective displaying system in a vehicle of claim 1, further comprising an image amplifying film deposited onto the optical display for amplifying the electrical image before the electrical image is projected onto the optical processing film.

4. The real-time optical projective displaying system in a vehicle of claim 1, wherein the optical display is a mobile device with navigation function.

5. The real-time optical projective displaying system in a vehicle of claim 1, further comprising a real-time image reverse unit installed in the optical display for inverting the electrical image before the electrical image is projected onto the optical processing film.

6. The real-time optical projective displaying system in a vehicle of claim 5, wherein the real-time image reverse unit comprises an application program of the optical display.

7. The real-time optical projective displaying system in a vehicle of claim 1, wherein an angle between the optical processing film and the optical display is from 0 degree to 180 degrees.

8. A real-time optical projective displaying system in a vehicle, comprising:
a see-through plate saw through by a human eye ;
a first optical processing film adhered on the see-through plate;
a reflection plate saw through by the human eye and faced to the see-through plate;
a second optical processing film adhered on the reflection plate and faced to the first optical processing film; and
an optical display deposited beneath the see-through plate and between the see-through plate and the reflection plate, a screen of the optical display being aligned with both position of the first processing film adhered on the see-through plate and position of the second optical processing film adhered on the reflection plate, and allowing the second optical processing film to receive an electrical image shown on the optical display, wherein the reflection plate is near the optical display and has an angle between the screen of the optical display and the reflection plate, and wherein electrical image is real-time projected onto the second optical processing film through the optical display, reflected by the second optical processing film onto the first optical processing film, and reflected by the first optical processing film into the human eye.

9. The real-time optical projective displaying system in a vehicle of claim 8, wherein the angle is more than 0 degree and less than 180 degrees.

10. The real-time optical projective displaying system in a vehicle of claim 8, further comprising a display housing device enclosing hollow space and comprising a top lid, the hollow space for depositing the optical display, the reflection plate adhered on the top lid, and the top lid rotatable with respect to the hollow space.

11. The real-time optical projective displaying system in a vehicle of claim 8, wherein the first optical processing film is a trans-flective film, and the second optical processing film is a trans-flective film or a total reflection film.
